(19) United States
(12) Patent Application Publication
(10) Pub. No.: US 2023/0051096 A1
(43) Pub. Date: Feb. 16, 2023

(54) SCANNER ASSEMBLIES WITH INCLINED NOTCHES

(71) Applicant: Hewlett-Packard Development Company, L.P., Spring, TX (US)

(72) Inventors: Xiao-Li Yang, Shanghai (CN); Xu-Ri Zhu, Shanghai (CN); Shuang-Kun Zhu, Shanghai (CN); Zhi Wen Xing, Shanghai (CN); Zhi Yuan Zhao, Shanghai (CN); Yue Jing, Shanghai (CN)

(21) Appl. No.: 17/792,995

(22) PCT Filed: Jan. 20, 2020
(86) PCT No.: PCT/CN2020/073156

§ 371 Date: Jul. 14, 2022

(51) Int. Cl. H04N 1/00

(52) U.S. Cl. CPC H04N 1/00737; H04N 1/00785; H04N 1/00742

(57) ABSTRACT

A scanner assembly (100) may include a housing (102) having abase (104) forming a cavity with an open top. Further, the housing (102) may include a platen (106) having a top surface (108) and a bottom surface (110). The bottom surface (110) may be attached to the base (104) around a periphery of the cavity. Furthermore, the housing (102) may include a bezel (112) adhered to the top surface of the platen (106) to cover an edge region of the top surface (108). The bezel (112) may include a bottom surface (114) having an inclined notch (116). Furthermore, the scanner assembly (100) may include a scanner module (118) movably disposed in the housing (102) below the platen (106). The scanner module (118) may be in an optical communication with the inclined notch (116) to detect a home position.

### BACKGROUND

Scanners, such as flatbed scanners, may have a platen where a user can place an object to be scanned. Once the object is placed on the platen, a scanner module may move underneath the platen to scan and read the object through the platen. Flatbed scanners may also have automatic document feeder (ADF) that moves the media past a smaller ADF scan window. Such flatbed scanners may be configured as a standalone device or may be integrated into a multi-function printer (MFP) or a copier.

### BRIEF DESCRIPTION OF THE DRAWINGS

Examples are described in the following detailed description and in reference to the drawings, in which:

FIG. 1A is a cross sectional view of an example scanner assembly, depicting an inclined notch;

FIG. 1B is a cross sectional view of the example scanner assembly of FIG. 1A, depicting a platen and a bezel having the inclined notch;

FIG. 1C is a schematic representation of the example scanner assembly of FIG. 1A, depicting additional features;

FIG. 1D is a bottom view of a portion of the example bezel of FIG. 1B, depicting the inclined notch;

FIG. 2A is a cross sectional view of an example scanner assembly, depicting an inclined notch;

FIG. 2B is a cross sectional view of the example scanner assembly of FIG. 2A, depicting an enlarged view of the inclined notch;

FIG. 3A is a partial sectional perspective view of an example image forming apparatus, depicting a scanner assembly coupled to a printer assembly;

FIG. 3B is a perspective view of the example image forming apparatus of FIG. 3A, depicting additional features; and

FIG. 3C is a cross sectional side view of the example scanner assembly of FIG. 3B, depicting a platen, bezel, and cover member.

### DETAILED DESCRIPTION

Multifunction machines may include an upper unit having a scanner function that may be rotatably attached to a main body having a printer function. The upper unit may be disposed on the main body to expose and cover an access opening formed in an upper surface of the main body. The upper unit can be rotated to an open position relative to the main body to expose the access opening, thereby enabling services such as removing a cartridge or a small size paper (e.g., jammed paper) from, or inserting a cartridge into the main body. The upper unit may include a scanner assembly (e.g., an integrated scanner assembly (ISA)) including a platen on which a document can be placed and a cover member (e.g., an automatic document feeder (ADF)) that covers the platen. The cover member may be pivoted to an open position to expose the platen (e.g., to place a document on the platen) and to a closed position to cover the platen. The ISA may be designed to be compact and low cost. Therefore, the ISA may have a significantly thin material thickness, for instance, of about 2 mm.

Such scanner assemblies may include a scanner module having an optical sensor and a transmission mechanism. The scanner module may be used to capture an image of an object to be scanned. When a scan is completed, the scanner module may be returned to a home position. In some examples, in an image forming apparatus that optically reads a print medium placed on a platen and converts into electronic data, a sheet member may be provided with a mark for detecting the home position and adjusting a positional deviation. In such scenarios, when the home position is adjusted, the optical sensor may detect the position by reading the mark provided on the sheet member and adjust the scanner module position.

In some other examples, a hole/slit corresponding to the above- mentioned mark may be provided in a sheet member. When adjusting the home position, the black position detected when reading the hole portion may be used to determine the home position. In order to clarify the density difference between the mark portion provided on the sheet member and the other portion, the portion detected by the optical sensor through the mark or hole may have to be processed to print the mark portion or through hole portion in black. However, providing the mark or hole on the sheet member may affect the aesthetic appearance of the scanner assemblies as the mark or hole can be visible when the sheet member is in the open position.

Examples described herein may provide a scanner assembly having a platen and a bezel adhered to the platen. The bezel may include a bottom surface having an inclined notch. The inclined notch may refer to an opening defined by side surfaces and an inclined bottom surface. The inclined bottom surface may have a thickness that varies from a first end to a second end. Further, the scanner assembly may include a scanner module (e.g., a contact image sensor (CIS) scanner module) movably disposed below the platen. The scanner module may be in an optical communication with the inclined notch to detect a home position of the scanner module.

In the examples described herein, the inclined notch provided on the bottom surface of the bezel may not be exposed, and hence can enhance the aesthetic appearance of the scanner assembly. Further, the bezel may have a significantly thin material thickness, for instance, of about 2 mm. However, the notch may need a depth of about 1.4 mm in order to detect the home position. In this example, the inclined bottom surface may have a thickness of about 1 mm at one side, which may be significant to reduce moulding and cosmetic issues of the bezel. Further, the inclined notch may have a depth of about 1.4 mm at another side, which may facilitate the inclined notch functionality to detect the home position. Thus, the inclined notch described herein may balance the material thickness while facilitating the notch function.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described may be included in at least that one example, but not necessarily in other examples.

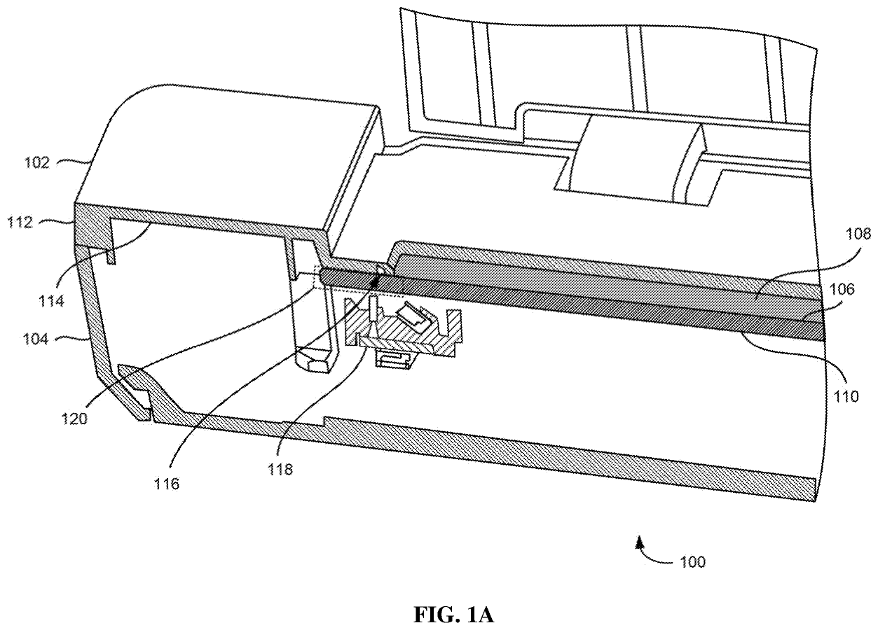

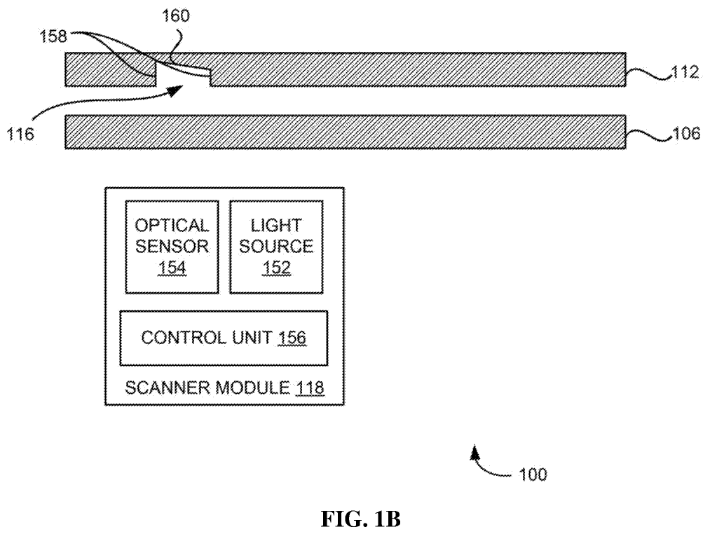

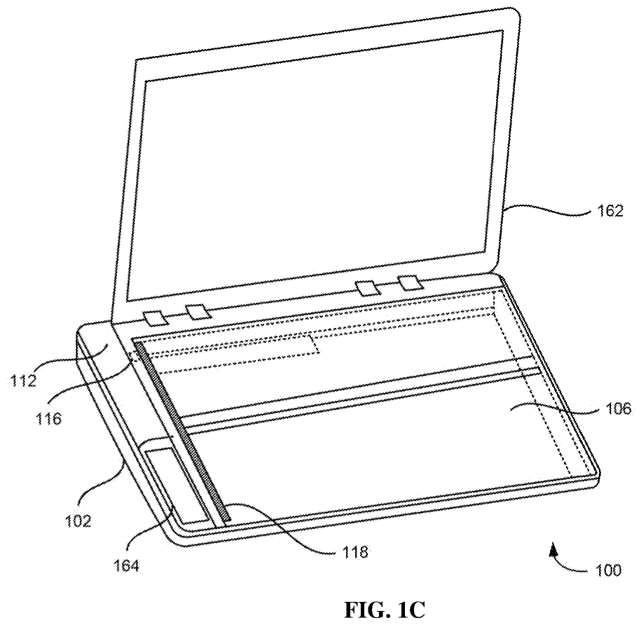

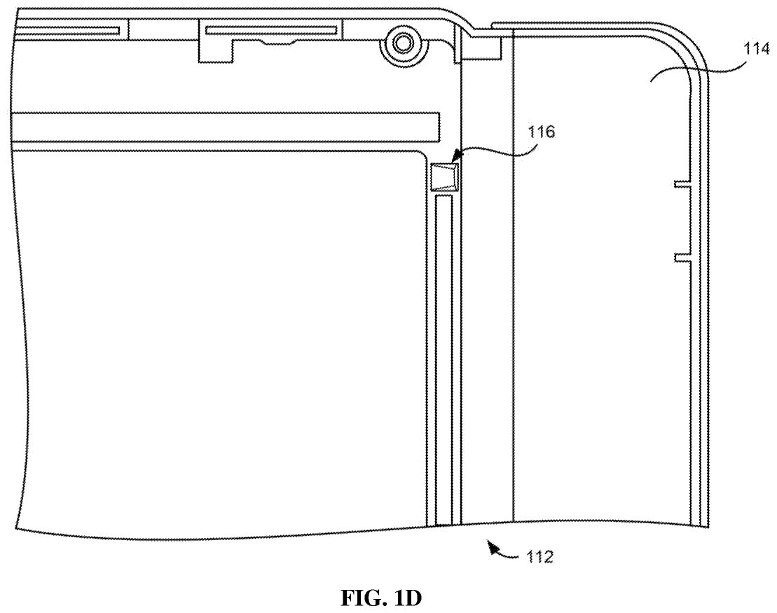

Referring now to the figures, FIG. 1A is a cross sectional view of an example scanner assembly 100, depicting an inclined notch 116. Example scanner assembly 100 may include a housing 102. Housing 102 may include a base 104 forming a cavity with an open top. Further, housing 102 may include a platen 106 having a top surface 108 and a bottom surface 110. In one example, bottom surface 110 may be attached to base 104 around a periphery of the cavity. For example, platen 106 may refer to a flat glass surface of scanner assembly 100 (e.g., a scanner, a photocopier, or the like) on which a medium to be scanned can be placed.

Further, housing 102 may include a bezel 112 adhered to top surface 108 of platen 106 to cover an edge region 120 of top surface 108. For example, bezel 112 may be adhered to top surface 108 of platen 106 to cover at least one edge region using glue, epoxy, or double-sided tape.

Furthermore, bezel 112 may include a bottom surface 114 having inclined notch 116. As shown in FIG. 1A, edge region 120 of platen 106 may cover inclined notch 116 on bottom surface 114 of bezel 112. Also, scanner assembly 100 may include a scanner module 118 movably disposed in housing 102 below platen 106. Example scanner module 118 may include a contact image sensor (CIS). Scanner assembly 100 may read an image of the medium placed on platen 106 using scanner module 118. In one example, scanner module 118 may be in an optical communication with inclined notch 116 to detect a home position of scanner module 118.

FIG. 1B is a cross sectional view of example scanner assembly 100 of FIG. 1A, depicting platen 106 and bezel 112 having inclined notch 116. For example, similarly named elements of FIG. 1B may be similar in structure and/or function to elements described with respect to FIG. 1A. As shown in FIG. 1B, inclined notch 116 may include an opening defined by side surfaces 158 and an inclined bottom surface 160. For example, the opening may be a rectangular hole defined by four side surfaces 158 and inclined bottom surface 160. In other examples, the opening may be of any other quadrilateral shape such as a square, parallelogram, and the like.

Further, as shown in FIG. 1B, scanner module 118 may include a light source 152 to emit light through platen 106 into inclined notch 116 while scanner module 118 moves along a scanning path. Example light source 152 may include an LED, a lamp, or the like. During operation, light source 152 may irradiate light to the medium placed on platen 106. In this example, edge region 120 of platen 106 may cover inclined notch 116 such that the light from light source 152 may pass through platen 106 into inclined notch 116.

Furthermore, scanner module 118 may include an optical sensor 154 to detect reflected light from the medium and then detect a shadow (i.e., a reflected light) of an end portion of inclined notch 116 projected by the light emitted from light source 152 based on the reflected light. In one example, optical sensor 154 may detect a reflection state of light by the medium based on the received light. That is, optical sensor 154 may detect a color of a specific portion on the medium, and can detect a state in which the portion is printed in black or printed in red. In other examples, optical sensor 154 may be a sensor that can detect a density of the medium and can detect white, black, or any intermediate colors thereof.

In some examples, light source 152 and optical sensor 154 may be arranged side by side in a scanning direction. In other examples, scanner assembly 100 may include a driving unit or a carriage to move scanner module 118 in the scanning direction, Also, scanner module 118 may include a control unit 156 to determine the home position based on a position of the shadow of an end of inclined notch 116 detected by optical sensor 154. In one example, control unit 156 may be implemented as an engine or a module including any combination of hardware and programming to implement the functionalities described herein.

FIG. 1C is a schematic representation of example scanner assembly 100 of FIG. 1A, depicting additional features. For example, similarly named elements of FIG. 1C may be similar in structure and/or function to elements described with respect to FIG. 1A. As shown in FIG. 1C, scanner assembly 100 may include a platen cover 162 pivotally mounted to housing 102 between an open position and a closed position. Platen cover 162 may be pivoted to an open position to expose platen 106 (e.g., to place a document on platen 106) and to a closed position to cover platen 106.

Further, scanner assembly 100 may include a control panel 164 to control various aspects of scanning, copying, printing, and/or other functions. For example, control panel 164 may include a button such as a start button to initiate the scanning or copying operation. Also, as shown in FIG. 1C, bezel 112 may include inclined notch 116 (e.g., as shown by dotted lines) on bottom surface.

Also, as shown in FIG. 1C, scanner module 118 can be moved in the scanning direction. Scanner module 118 may be formed to extend in a width direction of scanner assembly 100 perpendicular to the scanning direction when viewed from above and may have a length longer than a width of the medium that can be placed on platen 106. That is, scanner module 118 may include a plurality of light sources and optical sensors arranged in an array in the length direction of scanner module 118.

FIG. 1D is a bottom view of a portion of example bezel 112 of FIG. 1B, depicting inclined notch 116. For example, similarly named elements of FIG. 1D may be similar in structure and/or function to elements described with respect to FIG. 1B. As shown in FIG. 1 D, inclined notch 116 may be formed on bottom surface 114 of bezel 112 and adjacent to a flatbed scanning window.

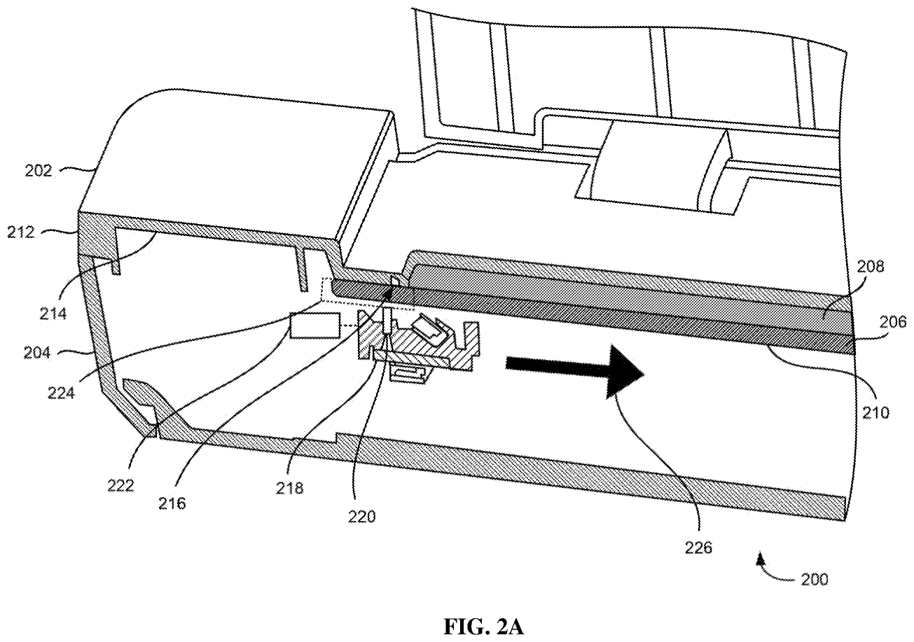

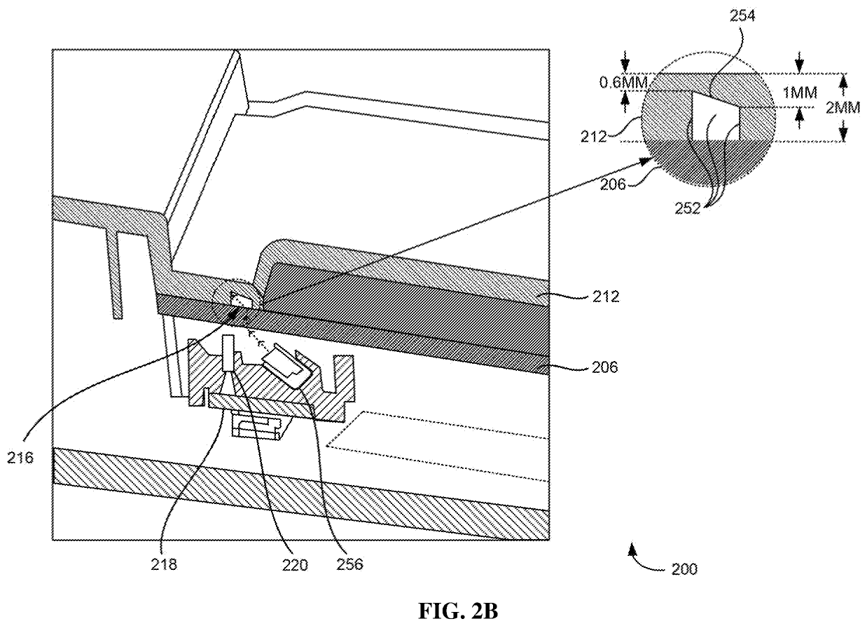

FIG. 2A is a cross sectional view of an example scanner assembly 200, depicting an inclined notch 216. Example scanner assembly 200 may include a housing 202. Housing 202 may include a base 204 forming a cavity with an open top. Further, housing 202 may include a platen 206 having a top surface 208 and a bottom surface 210. Bottom surface 210 may be attached to base 204 around a periphery of the cavity. Furthermore, housing 202 may include a bezel 212 adhered to top surface 208 of platen 206 to cover an edge 224 of top surface 208. In one example, bezel 212 may include a bottom surface 214 having inclined notch 216 covered by edge 224.

Further, scanner assembly 200 may include a scanner module 218 movably disposed in housing 202 below platen 206. In one example, scanner module 218 may include an image sensor 220 to continuously capture images including an image of inclined notch 216 as scanner module 218 moves along a scanning path (e.g., a horizontal direction as shown by an arrow 226). Scanner module 218 may be movable in a direction of arrow 226 or in an opposite direction to arrow 226.

Also, scanner assembly 200 may include a controller 222, coupled to scanner module 218, to determine a home position of scanner module 218 based on the captured images. In one example, controller 222 may determine the home position of scanner module 218 by identifying the image of inclined notch 216 from the captured images (e.g., by processing the captured images). For example, processing the captured images may include comparing the captured images with a stored image of inclined notch 216 (e.g., a black-white transition) to determine whether a match has been identified.

In some examples, inclined notch 216 may be formed in an area outside a flatbed scanning window of scanner assembly 200. In an example operation, inclined notch 216 may be scanned to obtain an image. Further, controller 222 may identify whether the image includes a home position pattern (i.e., a shadow or a black portion detected when reading inclined notch 216). When the image is determined to include the home position pattern, then controller 222 may set a scan initial line according to the image and adjust scanner module 218 to the scan initial line.

FIG. 2B is a cross sectional view of example scanner assembly 200 of FIG. 2A, depicting an enlarged view of inclined notch 216. For example, similarly named elements of FIG. 2B may be similar in structure and/or function to elements described with respect to FIG. 2A. As shown in FIG. 2B, scanner module 218 may include a light source 256 and optical sensor 220 that may be arranged side by side in a scanning direction.

Further, as shown in FIG. 2B, inclined notch 216 may include an opening defined by side surfaces 252 (e.g., on four sides) and an inclined bottom surface 254. In one example, bezel 212 may have a thickness of about 2 mm. In this example, inclined bottom surface 254 may have a thickness of about 1 mm at a first end and about 0.6 mm at a second end that is opposite to the first end. Thus, inclined bottom surface 254 may balance the material thickness while facilitating the notch function to detect the home position.

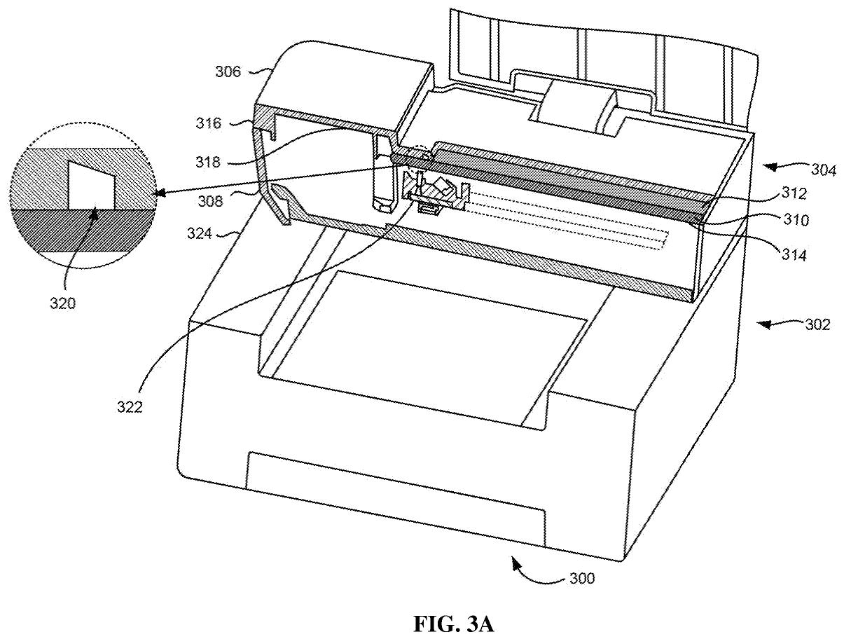

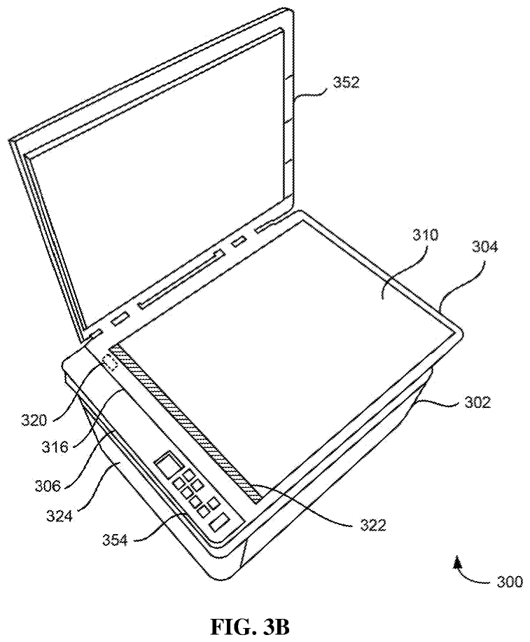

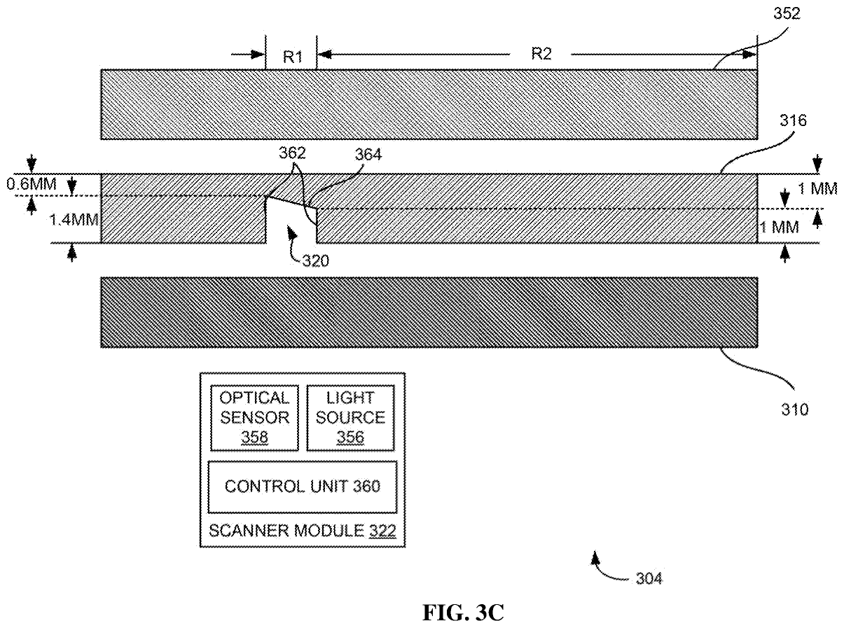

FIG. 3A is a partial sectional perspective view of an example image forming apparatus 300, depicting a scanner assembly 304 coupled to a printer assembly 302. Example image forming apparatus 300 may have a printer function, a scanner function, a copy function, a facsimile function, or any combination thereof.

As shown in FIG. 3A, image forming apparatus 300 may include printer assembly 302 and scanner assembly 304 disposed above printer assembly 302. For example, image forming apparatus 300 may achieve the printer function through printer assembly 302, the scanner function through scanner assembly 304, and the copier function through a combination of these functions.

For example, printer assembly 302 may be provided with an ink-jet printer. Scanner assembly 304 may include a flatbed scanner (e.g., a platen 310 on which a document can be placed and a scanner module 322 that reads images from the document). Further, an access opening for maintenance may be formed on an upper surface of printer assembly 302.

Further, image forming apparatus 300 may include a hinge assembly to pivotably connect scanner assembly 304 to printer assembly 302 between a closed position and an open position. scanner assembly 304 can be opened to access the access opening, for instance, to replace a cartridge.

As shown in FIG. 3A, printer assembly 302 may include a printer housing 324 to house printer components such as the ink-jet printer, cartridge, and the like. Further, scanner assembly 304 may include a scanner housing 306. In one example, scanner housing 306 may include a base 308 forming a cavity with an open top. Furthermore, scanner housing 306 may include platen 310 having a top surface 312 and a bottom surface 314. In one example, bottom surface 314 may be attached to base 308 around a periphery of the cavity.

In one example, scanner housing 306 may include a bezel 316 adhered to top surface 312 of platen 310 to cover an edge region of top surface 312. In other examples, a portion of bezel 316 may divide platen 310 into two sections (i.e., a flatbed window and an Automatic Document Feeder (ADF) window) and may be adhered to top surface 312 of platen 310. In this example, platen 310 may be a single sheet of material and bezel 316 may cover top surface 312 of at least one edge of platen 310. Further, bezel 316 may include a bottom surface 318 having an inclined notch 320.

Further, scanner assembly 304 may include scanner module 322 movably disposed in scanner housing 306 below platen 310. In one example, scanner module 322 may be in an optical communication with inclined notch 320 to detect a home position.

FIG. 3B is a perspective view of example image forming apparatus 300 of FIG. 3A, depicting additional features. For example, similarly named elements of FIG. 3B may be similar in structure and/or function to elements described with respect to FIG. 3A. As shown in FIG. 3B, scanner assembly 304 may include a cover member 352 disposed on a top surface of scanner assembly 304. Cover member 352 can be opened to access the flatbed scanner in scanner assembly 304. For example, cover member 352 may include a lower surface, which faces the flatbed scanner when cover member 352 is in the closed position.

Further, as shown in FIG. 3B, image forming apparatus 300 may include a control panel 354 disposed on scanner assembly 304. In some examples, control panel 354 including control buttons and a display can be provided on scanner housing 306, printer housing 324, or a combination thereof. Further, inclined notch 320 may be provided on a bottom surface of bezel 316 and thereby enhances the aesthetic appearance as inclined notch 320 may not be exposed to outside.

FIG. 3C is a cross sectional side view of example scanner assembly 304 of FIG. 3B, depicting platen 310, bezel 316, and cover member 352. For example, similarly named elements of FIG. 3C may be similar in structure and/or function to elements described with respect to FIG. 3B. As shown in FIG. 3C, inclined notch 320 may have a depth range less than a thickness of bezel 316. Further, as shown in FIG. 3C, inclined notch 320 may include an opening (e.g., a blind hole) defined by edges 362 and an inclined bottom surface 364 having a thickness that varies from a first end to a second end.

For example, bezel 316 may have a thickness of about 2 mm. In this example, the depth range may vary from about 1.4 mm at the first end to about 1 mm at the second end that is opposite to the first end. In other words, inclined bottom surface 364 may have a thickness that varies from about 0.6 mm at the first end to about 1 mm at the second end that is opposite to the first end. In this example, the depth of about 1.4 mm at the first end may facilitate the inclined notch functionality to detect the home position and the depth of about 1 mm at the second end may reduce moulding and cosmetic issues of bezel 316.

Further, scanner module 322 may include a light source 356 to emit light through platen 310 into inclined notch 320 while scanner module 322 moves along a scanning path. Furthermore, scanner module 322 may include an optical sensor 358 to detect a shadow of an end portion of inclined notch 320 projected by the light emitted from light source 356. In addition, scanner module 322 may include a control unit 360 to detect the home position based on the detected shadow.

For example, cover member 352 and a calibration sheet of cover member 352 may be formed in white. When light source 356 irradiates the calibration sheet with light, cover member 352 and the calibration sheet may be detected in white. However, as shown in FIG. 3C, since light source 356 and optical sensor 358 may be arranged side by side in the scanning direction, optical sensor 358 may detect the shadow projected by inclined notch 320 formed on bezel 316. For example, a portion of R2 shown in FIG. 3C is a scan of the calibration sheet, and the results may be white detection results. Regarding the portion R1, R1 is a portion where the shadow is formed by the end of inclined notch 320 when the light is emitted from light source 356 and optical sensor 358 may detect a black portion (i.e., the shadow) of R1. Further, control unit 360 may detect the home position based on the detected black portion.

In some examples, a size of the shadow may be determined by the depth of inclined notch 320. Therefore, by comparing the position and size of the shadow with a preset reference, relative positioning between scanner module 322, cover member 352, the calibration sheet, and platen 310 may be determined, and then the position can be specified and adjusted.

The above-described examples of the present solution are for the purpose of illustration. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

1. A scanner assembly comprising:
a housing comprising:
a base forming a cavity with an open top;
a platen having a top surface and a bottom surface, the bottom surface attached to the base around a periphery of the cavity; and
a bezel adhered to the top surface of the platen to cover an edge region of the top surface, wherein the bezel comprises a bottom surface having an inclined notch; and
a scanner module movably disposed in the housing below the platen, wherein the scanner module is in an optical communication with the inclined notch to detect a home position.

2. The scanner assembly of claim 1, wherein the inclined notch comprises an opening defined by side surfaces and an inclined bottom surface.

3. The scanner assembly of claim 1, wherein the edge region of the platen is to cover the inclined notch on the bottom surface of the bezel.

4. The scanner assembly of claim 1, wherein the scanner module comprises:
a light source to emit light through the platen into the inclined notch while the scanner module moves along a scanning path;
an optical sensor to detect a shadow of an end portion of the inclined notch projected by the light emitted from the light source; and
a control unit to determine the home position based on the detected shadow.

5. The scanner assembly of claim 1, further comprising:
a platen cover pivotally mounted to the housing between an open position and a closed position.

6. A scanner assembly comprising:
a housing comprising:
a base forming a cavity with an open top;
a platen having a top surface and a bottom surface, the bottom surface attached to the base around a periphery of the cavity; and
a bezel adhered to the top surface of the platen to cover an edge of the top surface, wherein the bezel comprises a bottom surface having
an inclined notch covered by the edge;
a scanner module movably disposed in the housing below the platen, wherein the scanner module comprises an image sensor to continuously capture images including an image of the inclined notch as the scanner module moves along a scanning path; and
a controller, coupled to the scanner module, to determine a home position of the scanner module based on the captured images.

7. The scanner assembly of claim 6, wherein the controller is to determine the home position of the scanner module by identifying the image of the inclined notch from the captured images.

8. The scanner assembly of claim 6, wherein the inclined notch comprises an opening defined by side surfaces and an inclined bottom surface.

9. The scanner assembly of claim 8, wherein the inclined bottom surface has a thickness of about 1 mm at a first end and about 0.6 mm at a second end that is opposite to the first end.

10. The scanner assembly of claim 6, wherein the bezel has a thickness of about 2 mm.

11. An image forming apparatus comprising:
a printer assembly including a printer housing; and
a scanner assembly coupled to the printer assembly, wherein the scanner assembly comprising:
a scanner housing comprising:
a base forming a cavity with an open top;
a platen having a top surface and a bottom surface, the bottom surface attached to the base around a periphery of the cavity; and
a bezel adhered to the top surface of the platen to cover an edge region of the top surface, wherein the bezel comprises a bottom surface having an inclined notch; and
a scanner module movably disposed in the scanner housing below the platen, wherein the scanner module is in an optical communication with the inclined notch to detect a home position.

12. The image forming apparatus of claim 11, wherein the inclined notch has a depth range less than a thickness of the bezel, and wherein the bezel has a thickness of about 2 mm.

13. The image forming apparatus of claim 12, wherein the depth range varies from about 1.4 mm at a first end to about 1 mm at a second end that is opposite to the first end.

14. The image forming apparatus of claim 11, wherein the inclined notch comprises an opening defined by edges and an inclined bottom surface having a thickness that varies from a first end to a second end.

15. The image forming apparatus of claim 11, wherein the scanner module comprises:
a light source to emit light through the platen into the inclined notch while the scanner module moves along a scanning path;
an optical sensor to detect a shadow of an end portion of the inclined notch projected by the light emitted from the light source; and
a control unit to detect the home position based on the detected shadow.
